(19) United States
(12) Patent Application Publication
(10) Pub. No.: US 2022/0397432 A1
(43) Pub. Date: Dec. 15, 2022

(54) ARTICLE MANAGEMENT DEVICE AND METHOD

(71) Applicant: Toshiba Tec Kabushiki Kaisha, Tokyo (JP)

(72) Inventor: Shigeaki SUZUKI, Gotemba (JP)

(73) Assignee: Toshiba Tec Kabushiki Kaisha, Tokyo (JP)

(21) Appl. No.: 17/585,194

(22) Filed: Jan. 26, 2022

(30) Foreign Application Priority Data
Jun. 10, 2021 (JP) 2021-097561

(51) Int. Cl. G01D 9/00; G04F 10/00

(52) U.S. Cl. CPC G01D 9/007; G04F 10/00

(57) ABSTRACT

An article management device includes a processing circuit. The processing circuit is configured to repeatedly acquire, from a wireless tag attached to an article where the wireless tag is capable of measuring an environmental physical quantity related to the article, identification information that identifies the wireless tag and the environmental physical quantity; monitor an amount of time that the environmental physical quantity exceeds a first threshold value in response to the environmental physical quantity exceeding the first threshold value; and record the amount of time in association with the identification information.

### CROSS-REFERENCE TO RELATED APPLICATION

This application is based upon and claims the benefit of priority from Japanese Patent Application No. 2021-097561, filed on Jun. 10, 2021, the entire contents of which are incorporated herein by reference.

### FIELD

Embodiments described herein relate to an article management device and a method.

### BACKGROUND

In the related art, a device in which a sensor capable of acquiring an article state is attached to an article, and the article state is managed is proposed. For example, a technique in which a device periodically measures a temperature of an article to manage an article state at each measurement is proposed.

However, in the related art, it is possible to acquire the temperature of the article at the time of measurement by periodically measuring the temperature, but it is difficult to acquire, for example, how much time passes since the temperature exceeds a threshold value. Therefore, there is room for further improving state management of the article.

### DESCRIPTION OF THE DRAWINGS

FIG. 1 is a block diagram showing an example of a hardware configuration of an article management device according to an embodiment;

FIG. 2 is a functional configuration diagram showing an example of functions of the article management device;

FIG. 3 is a schematic configuration diagram showing an example in which the article management device reads an article;

FIG. 4 is a diagram showing an example of a table in which the article management device records information on the article; and

FIG. 5 is a flowchart showing an example of processing executed by the article management device.

### DETAILED DESCRIPTION

In general, according to one embodiment, an article management device and a method capable of efficiently managing an article state is provided.

An article management device according to an embodiment includes: an acquisition unit configured to repeatedly acquire, from a wireless tag that is capable of measuring an environmental physical quantity related to an article quality state attached to an article, identification information that is capable of identifying the wireless tag and the environmental physical quantity; a clock processing unit configured to, when the environmental physical quantity acquired by the acquisition unit exceeds a first threshold value, clock a time exceeding the first threshold value; and a management unit configured to manage the time clocked by the clock processing unit in association with the identification information.

Hereinafter, an embodiment of an article management device will be described in detail with reference to the drawings. The present embodiment describes an example in which an article management device is applied to a device for managing a state of a vaccine contained in a container such as a vial, but the present embodiment is not limited to this example. In the following, the container containing the vaccine is also simply referred to as a vaccine.

### Hardware Configuration of Article Management Device

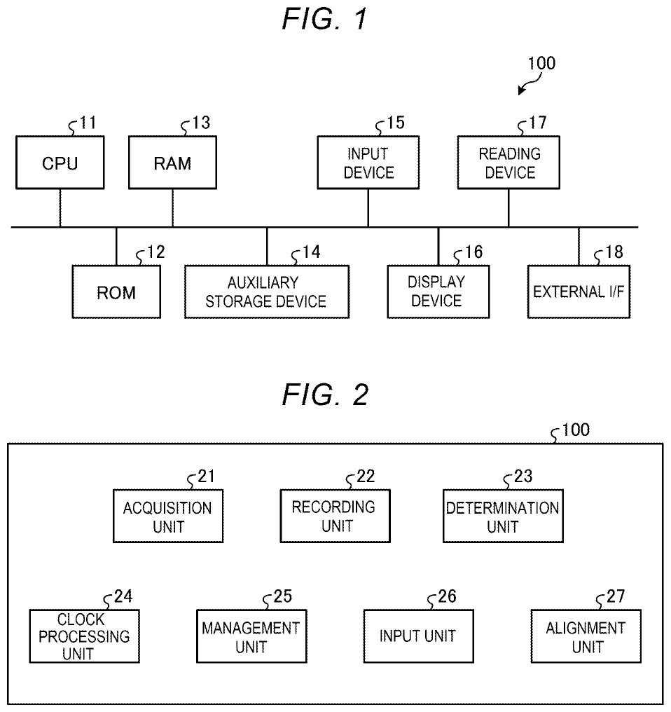

As shown in FIG. 1, an article management device 100 includes a a processing circuit or central processing unit (CPU) 11, a read only memory (ROM) 12, a random access memory (RAM) 13, an auxiliary storage device 14, an input device 15 (a user input), a display device 16 (a display), a reading device 17 (a reader), and an external interface (I/F) 18.

The CPU 11 is an arithmetic unit that realizes functions of the article management device 100 by reading programs and data stored in the ROM 12, the auxiliary storage device 14, and the like onto the RAM 13 and executing a processing. The RAM 13 is a volatile memory used as a work area or the like of the CPU 11. The ROM 12 is a non-volatile memory.

The auxiliary storage device 14 is, for example, a recording device such as a hard disk drive (HDD) or a solid state drive (SSD), and records, for example, an operation system (OS), an application program, various data, and the like. The input device 15 is a device for a user who uses the article management device 100 to perform various operations. The input device 15 includes, for example, a touch panel or a hardware key.

The display device 16 is a display that displays various information read by the reading device 17. The display device 16 includes, for example, a liquid crystal display. The input device 15 and the display device 16 may be integrally configured in a form such as a touch panel.

The reading device 17 is a device that reads, from each wireless tag that is attached to each article to be managed (e.g., each vaccine) and is capable of measuring an environmental physical quantity related to an article quality state, identification information capable of identifying the article and the environmental physical quantity. The environmental physical quantity is, for example, a measurable physical quantity of an article itself or the environment around the article, such as temperature, humidity, and illuminance. As an example, for an article whose quality may deteriorate or degrade when the article is placed at a temperature equal to or higher than a threshold value, a wireless tag for measuring the temperature as an environmental physical quantity is attached to the article.

The reading device 17 may be a wireless tag reader-writer that has an antenna and detects the wireless tag attached to the article existing within a communication region range of the antenna. That is, the wireless tag reader-writer transmits a radio wave from the antenna to a wireless tag on the periphery. When the wireless tag receives the radio wave from the antenna, the wireless tag transmits a response signal to the wireless tag reader-writer.

The wireless tag reader-writer reads tag information recorded in a memory of the wireless tag by receiving the response signal from the wireless tag. The tag information includes the identification information and environmental physical quantity described above. A method called anti-collision (collision prevention) is used for communication control between the wireless tag reader-writer and the wireless tag. As a result, when a plurality of wireless tags exist in a communicable region of the antenna, the tag information of each wireless tag is collectively read by the wireless tag reader-writer.

The wireless tag has a non-volatile memory inside. In this memory, an ID area for recording a unique identifier (ID) assigned and set by a manufacturer at a stage of manufacturing a wireless tag, and a user area in which a user can write any data are formed.

In addition, the wireless tag has a built-in sensor that measures the environmental physical quantity of the article. For example, the sensor is a temperature sensor that measures a temperature of the article. In the present embodiment, the user area of the wireless tag is written with the identification information and the temperature of the article as an environmental physical quantity measured by the temperature sensor. The wireless tag reader-writer reads the ID, the identification information, and the environmental physical quantity from the wireless tag as tag information. For example, the wireless tag is a radio frequency identification (RFID).

The wireless tag reader-writer controls the tag information (identification information) including the same ID so as not to be read in duplicate by performing a duplication check based on the ID included in the read tag information. Then, in the article management device 100, recording processing of the article can be performed based on the identification information read by the wireless tag reader-writer.

The external I/F 18 is a communication interface for connecting the article management device 100 to a network.

Next, functional configurations of the article management device 100 according to the embodiment will be described. FIG. 2 is a block diagram showing an example of the functional configurations of the article management device 100. The article management device 100 functions as an acquisition unit 21, a recording unit 22, a determination unit 23, a clock processing unit 24, a management unit 25, an input unit 26, and an alignment unit 27 by the CPU 11 operating according to a control program recorded in the ROM 12 or the RAM 13. Each of the functional configurations may be realized by the hardware as long as the article management device 100 has the above functions.

The acquisition unit 21 cooperates with the reading device 17 to repeatedly acquire, from a wireless tag capable of measuring an environmental physical quantity related to an article quality state attached to an article, the tag information including identification information capable of identifying the wireless tag and the environmental physical quantity. For example, when the reading device 17 detects the article, the acquisition unit 21 starts reading of the wireless tag by operating the reading device 17, and acquires the identification information of the article and the environmental physical quantity related to the article quality state read by the reading device 17.

The acquisition unit 21 repeatedly acquires the identification information and the environmental physical quantity that are recorded on the wireless tag of the article from the reading device 17 at a predetermined time interval. The acquisition unit 21 can appropriately grasp a state of the article by repeatedly acquiring the information at the predetermined time intervals. The predetermined time interval may be predetermined according to a characteristic of the quality state of the article, or the time interval may be determined by the user, and is not limited thereto.

The recording unit 22 records the identification information and the environmental physical quantity that are acquired by the acquisition unit 21 in association with an acquisition date and time. Here, the acquisition date and time indicates a date and time acquired by the acquisition unit 21. The acquisition date and time is acquired by the acquisition unit 21 from a real-time clock (RTC) of the article management device 100, for example.

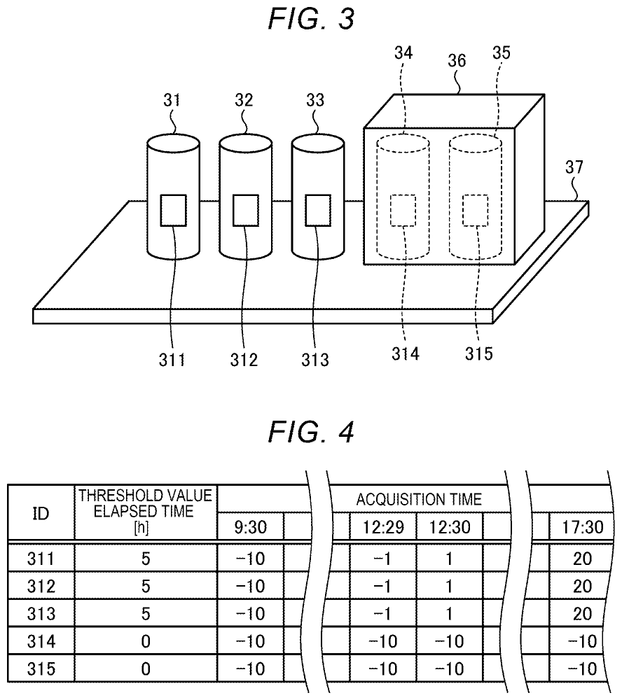

Here, with reference to FIG. 3, a method for acquiring information on a wireless tag attached to an article by the article management device 100 will be described. FIG. 3 is a schematic configuration diagram showing an example of an outline in which the article management device 100 reads the article. FIG. 3 shows vaccines 31, 32, 33, 34, and 35 as an example of articles, a container 36, and a mounting table 37.

The vaccines 31, 32, 33, 34, and 35 include wireless tags 311, 312, 313, 314, and 315 coupled thereto. The wireless tags 311, 312, 313, 314, and 315 are configured to measure environmental physical quantities related to quality states of articles. The container 36 contains the vaccines 34, 35 and manages the vaccines 34, 35 in an appropriate quality state. For example, the container 36 is a freezer. The mounting table 37 supports the vaccines 31, 32, and 33 and the container 36. In addition, the mounting table 37 includes an antenna of the reading device 17 (e.g., inside or below the mounting table 37).

In the case of FIG. 3, the acquisition unit 21 cooperates with the wireless tag reader-writer of the reading device 17 to repeatedly acquire identifiable identification information and environmental physical quantities from the wireless tags 311, 312, 313, 314, and 315 attached to the vaccines 31, 32, and 33 placed on the mounting table 37 and the vaccines 34, 35 located in the container 36. For example, the acquisition unit 21 starts reading the wireless tag by operating the wireless tag reader-writer, and acquires the tag information (identification information, environmental physical quantity) read by the wireless tag reader-writer.

In this case, since the vaccines 31, 32, and 33 mounted on the mounting table 37 and the vaccines 34, 35 in the container 36 are placed in different environments, the environmental physical quantity measured by the wireless tags also are different. Each time the acquisition unit 21 acquires the tag information, the recording unit 22 records the identification information and the environmental physical quantity included in the tag information in a table.

FIG. 4 is a diagram showing an example of a table in which the article management device 100 according to the embodiment records the article. The table is stored in the RAM 13 or the auxiliary storage device 14 of the article management device 100.

In the table shown in FIG. 4, an ID that is identification information capable of identifying each of the articles, an acquisition time indicating the time acquired by the acquisition unit 21, and a value of the temperature indicating the environmental physical quantity are recorded in units of ID for each column of the acquisition time in the table. In addition, the predetermined time interval acquired by the acquisition unit 21 of the present embodiment is 1 minute.

Returning to FIG. 2, the determination unit 23 determines whether the environmental physical quantity acquired by the acquisition unit 21 exceeds a first threshold value. Specifically, the determination unit 23 compares the preset first threshold value with the temperature of the vaccine acquired by the acquisition unit 21, and determines whether the temperature of the acquired vaccine exceeds the first threshold value.

The first threshold value is preferably set to the environmental physical quantity that is an upper limit value (or a lower limit value) in order to manage the quality of the vaccine. In the present embodiment, the first threshold value is a temperature at which the vaccine is thawed (e.g., 0 degrees). The first threshold value can be optionally set, and is not limited to this.

When the environmental physical quantity acquired by the acquisition unit 21 exceeds the first threshold value, the clock processing unit 24 clocks the time exceeding the first threshold value (i.e., starts a timer to monitor the length or amount of time the environmental physical quantity exceeds the first threshold, monitors a duration of time that the first threshold value is exceeded). Specifically, when the determination unit 23 determines that the first threshold value is exceeded, the clock processing unit 24 clocks the time exceeding the first threshold value. In addition, the clock processing unit 24 clocks the time exceeding the first threshold value based on the acquisition date and time recorded by the recording unit 22.

Here, an operation of the clock processing unit 24 will be described with reference to FIG. 4. For example, paying attention to the tag information acquired from a wireless tag 311 (ID: 311) of the vaccine 31, the temperature rises from 9:30 to 12:30, which is a time when the vaccine 31 is taken out from the container 36. In addition, the temperature rises from 12:29 to 12:30, and reaches 1 degree at 12:30.

As described above, since the first threshold value is 0 degrees, the determination unit 23 determines that the temperature of the vaccine 31 exceeds the first threshold value at 12:30. The clock processing unit 24 starts clocking the time when the first threshold value is exceeded according to a determination result of the determination unit 23.

For example, assuming that the temperature rises from 12:30 to 17:30, the clock processing unit 24 clocks 5 hours from 12:30 to 17:30 as a threshold value elapsed time. The threshold value elapsed time clocked by the clock processing unit 24 is recorded in the table by the recording unit 22. A recording method may be stored in a place other than the table, and is not limited to this.

In addition, the threshold value elapsed time is updated every time the clock processing unit 24 clocks, that is, every time the tag information is acquired by the acquisition unit 21. In addition, when the temperature of the article becomes equal to or less than the first threshold value due to a decrease in the temperature of the article on the way after the temperature of the article exceeds the first threshold value, a clock processing may be stopped. In that case, the threshold value elapsed time may be reset, or the time may be measured as a cumulative time, and the time is not limited to this. Returning to FIG. 2, the management unit 25 manages the time clocked by the clock processing unit 24 in the table in association with the identification information. A management method may be a method other than the table, and is not limited to this. In addition, the management unit 25 causes the display device 16 to display the table in response to the operation by the user via the input device 15.

The management unit 25 causes the display device 16 to display a temporal change in the identification information and the environmental physical quantity that are recorded by the recording unit 22 for each of the identification information. For example, when a graph of two axes is taken as an example as a temporal change, the management unit 25 causes the display device 16 to display the time acquired by the acquisition unit 21 on a horizontal axis and the temperature information acquired by the acquisition unit on a vertical axis for each identification information. The management unit 25 causes the display device 16 to display the identification information in association with the threshold value elapsed time.

In addition, the management unit 25 notifies the display device 16 when the time clocked by the clock processing unit 24 exceeds a second threshold value. Here, the second threshold value is a value in which the threshold value elapsed time exceeds a predetermined time in which it is difficult to maintain the quality of the article. For example, when the second threshold value is exceeded, the management unit 25 causes the display device 16 to display an awakening attention for “please confirm the vaccine because the threshold value elapsed time is exceeded”, and highlights the ID of the vaccine on the display device 16.

A notification method may be other than displaying on the display device 16, and is not limited to this. In addition, when the user confirms a content to be notified, the management unit 25 does not have to notify the user again, and the number of notifications may be set by setting a separate threshold value.

The input unit 26 cooperates with the input device 15 to operate items of the identification information, the environmental physical quantity, the acquisition date and time, and the threshold value elapsed time selected by the user in the table. The user uses the input unit 26 when the user wants to change the items displayed on the display device 16 or when the user wants to change the threshold value set by the article management device 100. For example, when the user changes the items displayed on the display device 16 by the management unit 25, the user inputs the items to the input unit 26. In addition, when the user wants to change the threshold value, the user inputs the changed threshold value to the input unit 26.

The alignment unit 27 rearranges a display order of information (environmental physical quantity, acquisition date and time, threshold value elapsed time) related to the identification information displayed on the display device 16 by the recording unit 22 according to the operation of the user. For example, the alignment unit 27 rearranges the display order so that identification information having a long threshold value elapsed time is displayed at the top. Accordingly, since the identification information having a long threshold value elapsed time can be easily recognized, convenience of article management can be improved.

In addition, the alignment unit 27 may rearrange the information displayed on the display device 16 according to the operation of the user via the input unit 26. For example, when the user wants to rearrange the information by a time exceeding the second threshold value, the alignment unit 27 rearranges the information in descending order in which the time exceeding the second threshold value is long. An alignment method can be set optionally and is not limited to this. In addition, the function of the alignment unit 27 may be realized by the management unit 25.

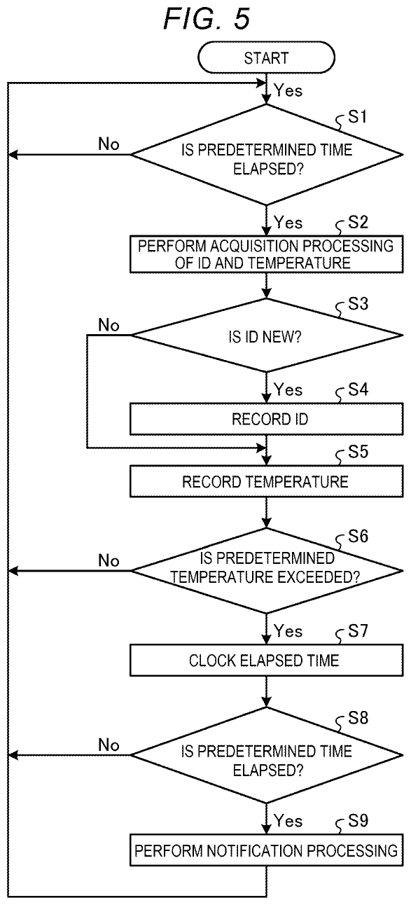

Next, an operation example of the article management device 100 having the configuration will be described with reference to FIG. 5. FIG. 5 is a flowchart showing an example of a processing executed by the article management device 100 according to the embodiment.

First, the acquisition unit 21 determines whether a predetermined time (for example, 1 minute), which is a time interval for acquiring tag information, is elapsed. If the predetermined time is elapsed (step S1: Yes), the process proceeds to step S2. If the predetermined time is not elapsed (step S1: No), the process is returned to step S1 again to wait until the predetermined time elapses.

Subsequently, the acquisition unit 21 acquires the tag information including the identification information (ID) and the environmental physical quantity (temperature) from the wireless tag attached to each of the articles (step S2). When the acquisition processing is performed, the process proceeds to step S3.

The recording unit 22 determines whether the acquired ID is a new ID that is not recorded in the table. When the acquired ID is new (step S3: Yes), the recording unit 22 records the new ID in the table (step S4) and the process proceeds to step S5. In addition, if the acquired ID is registered in the table (step S3: No), the process proceeds to step S5.

Subsequently, the recording unit 22 records the ID and temperature acquired by the acquisition unit 21 in association with the acquisition date and time (step S5), and the process proceeds to step S6.

Subsequently, the determination unit 23 determines whether the temperature acquired by the acquisition unit 21 exceeds the first threshold value (step S6). If the acquired temperature exceeds the first threshold value (step S6: Yes), the process proceeds to step S7. If the acquired temperature does not exceed the first threshold value (step S6: No), the process returns to step S1.

When the determination unit 23 determines that the acquired temperature exceeds the first threshold value, the clock processing unit 24 clocks the time exceeding the first threshold value (step S7). When the clock processing is performed, the clock processing unit 24 records the time clocked in the table. When the recording processing is performed, the management unit 25 manages the clocked time in association with the identification information.

Subsequently, the management unit 25 determines whether the elapsed time clocked by the clock processing unit 24 passes the second threshold value (i.e., the threshold value elapsed time). If the predetermined time is elapsed (step S8: Yes), the process proceeds to step S9. If the predetermined time is not elapsed (step S8: No), the process is returned to step S1 again to wait until the predetermined time elapses.

Subsequently, when it is determined that the second threshold value is exceeded, the management unit 25 notifies that the second threshold value is exceeded (step S9). The management unit 25 notifies the display device 16 of the identification information in which the display order is rearranged so that the one having the long threshold value elapsed time is displayed at the top by the alignment unit 27. When a notification processing is performed, the process is returned to step S1 again to wait until the predetermined time elapses.

As described above, in the article management device, the acquisition unit repeatedly acquires the identification information and the environmental physical quantities from the wireless tag attached to the article. In addition, when the first threshold value is exceeded, the clock processing unit clocks the time exceeding the first threshold value. Further, the management unit manages the clocked time in association with the identification information.

Thus, when the article exceeds the first threshold value of the environmental physical quantity, the exceeded time is clocked, and the clocked time is managed in association with the identification information. Since the article management device can grasp the state of the article from the managed information, the state of the article can be efficiently managed.

The embodiment can be appropriately modified and implemented by changing a part of the configuration or function of the device. Therefore, hereinafter, several modifications according to the embodiment will be described as other embodiments. Hereinafter, points differences from the embodiment described above will be mainly described, and detailed descriptions will be omitted for points in common with the content already described. Further, the modifications described below may be implemented individually or in combination as appropriate.

### Modification 1

In the embodiment, the article to be managed is used as the vaccine, but is not limited to this. For example, the article to be managed may be fresh food or the like. Further, for example, the container may be a refrigerator, as long as the article to be contained can be managed in an appropriate environment.

### Modification 2

In the embodiment, although the vaccine, which is the article to be managed, is attached with the wireless tag, for example, the container may be attached with the wireless tag.

### Modification 3

For example, the identification information stored in the wireless tag may be written on the vaccine. Therefore, the vaccine in a state where the first threshold value is exceeded can be easily confirmed.

### Modification 4

In the embodiment, in the case of the first threshold value or less, the content is also recorded in the table, but for example, the content to be recorded in the table may record in the case of the first threshold value or more.

### Modification 5

In the embodiment, the content to be notified is notified to the display device 16 of the article management device 100, but may be notified to, for example, a separate information processing terminal owned by the user. Thus, the user can manage the article even if the user is remote or away from a place where an article is supervised.

A computer program executed by the article management device 100 of the present embodiment is provided by being recorded in a computer-readable recording medium such as a CD-ROM, a flexible disk (FD), a CD-R, and a Digital Versatile Disk (DVD) in an installable format or an executable format.

In addition, the computer program executed by the article management device 100 of the present embodiment may be stored on the computer connected to a network such as the Internet and provided by be downloaded via the network. In addition, the computer program executed by the article management device 100 of the present embodiment may be provided or distributed via a network such as the Internet.

In addition, the computer program executed by the article management device 100 of the present embodiment may be provided by being incorporated in the ROM or the like in advance.

While several embodiments have been described, these embodiments have been presented by way of example and are not intended to limit the scope of the disclosure. These new embodiments can be implemented in other various forms, and various omissions, replacements, and changes can be made without departing from the spirit of the disclosure. These embodiments and modifications thereof are included in the scope and spirit of the disclosure and are also included in the disclosure described in the scope of claims and an equivalent scope thereof.

What is claimed is:

1. An article management device comprising:
a processing circuit configured to:
acquire, from a wireless tag attached to an article where the wireless tag is capable of measuring an environmental physical quantity related to the article, identification information that identifies the wireless tag and the environmental physical quantity;
monitor an amount of time that the environmental physical quantity exceeds a first threshold value in response to the environmental physical quantity exceeding the first threshold value; and
record the amount of time in association with the identification information.

2. The article management device according to claim 1, wherein the environmental physical quantity includes at least one of a temperature or a humidity measured by the wireless tag.

3. The article management device according to claim 1, wherein the processing circuit is configured to:
record the identification information and the environmental physical quantity that are acquired in association with an acquisition date and an acquisition time; and
monitor the amount of time that the first threshold value is exceeded based on the acquisition date and the acquisition time.

4. The article management device according to claim 3, wherein the processing circuit is configured to provide display information to a display device to display a temporal change in the environmental physical quantity.

5. The article management device according to claim 4, further comprising the display device.

6. The article management device according to claim 1, wherein the processing circuit is configured to provide a notification when the amount of time exceeds a second threshold value.

7. The article management device according to claim 1, further comprising a reader configured to detect and read the wireless tag attached to the article within a communication range thereof to obtain the identification information and the environmental physical quantity, wherein the processing circuit acquires the identification information and the environmental physical quantity from the reader.

8. A method executed by a computer of an article management device, the method comprising:
acquiring, by a processing circuit from a wireless tag attached to an article where the wireless tag is capable of measuring an environmental physical quantity related to the article, identification information that identifies the wireless tag and the environmental physical quantity;
monitoring, by the processing circuit, an amount of time that the environmental physical quantity exceeds a first threshold value in response to the environmental physical quantity exceeding the first threshold value; and
recording, by the processing circuit, the amount of time in association with the identification information.

9. The method according to claim 8, wherein the environmental physical quantity includes at least one of a temperature or a humidity measured by the wireless tag.

10. The method according to claim 8, wherein the environmental physical quantity includes a temperature of the article.

11. The method according to claim 8, further comprising providing, by the processing circuit, a notification when the amount of time exceeds a second threshold value.

12. The method according to claim 8, further comprising:
recording, by the processing circuit, the identification information and the environmental physical quantity that are acquired in association with an acquisition date and an acquisition time; and
monitoring, by the processing circuit, the amount of time that the first threshold value is exceeded based on the acquisition date and the acquisition time.

13. The method according to claim 8, further comprising providing, by the processing circuit, display information to a display device to display a temporal change in the environmental physical quantity.

14. The method according to claim 8, further comprising detecting and reading, by a reader, the wireless tag attached to the article within a communication range thereof to obtain the identification information and the environmental physical quantity, wherein the processing circuit acquires the the identification information and the environmental physical quantity from the reader.

15. An article management device comprising:
a plurality of wireless tags configured to be coupled to a plurality of articles, each of the plurality of wireless tags configured to store an identifier and measure a temperature of a respective article of the plurality of articles;
a reader configured to detect and read the identifier and the temperature from each of the plurality of wireless tags within a communication range thereof; and
a processing circuit configured to:
acquire the identifier and the temperature associated with each of the plurality of wireless tags from the reader;
record the identifier of each of the plurality of wireless tags and the temperature of each of the plurality of articles;
monitor the temperature of each of the plurality of articles over time;
determine the temperature of at least one of the plurality of articles exceeds a temperature threshold;
start a timer to record an amount of time that the temperature exceeds the temperature threshold; and
provide a notification in response to the amount of time exceeding a time threshold.

16. The article management device according to claim 15, further comprising a display.

17. The article management device according to claim 16, wherein the processing circuit is configured to provide the notification to the display.

18. The article management device according to claim 16, wherein the processing circuit is configured to control the display to display a temporal change in the temperature.

19. The article management device according to claim 15, wherein the processing circuit provides the notification to a remote device.
